(19) United States
(12) Patent Application Publication
(10) Pub. No.: US 2026/0131992 A1
(43) Pub. Date: May 14, 2026

(54) PRESSURIZING DEVICE FOR ELECTRODE PLATE

(71) Applicant: Samsung SDI Co., Ltd., Yongin-si (KR)

(72) Inventor: HANBYEOL NAMGUNG, Yongin-si (KR)

(21) Appl. No.: 19/349,806

(22) Filed: Oct. 3, 2025

(30) Foreign Application Priority Data
Nov. 11, 2024 (KR) 10-2024-0158977

(51) Int. Cl. B65H 20/02; B65H 20/10; H01M 10/04

(52) U.S. Cl. CPC B65H 20/02; B65H 20/10; H01M 10/0481

(57) ABSTRACT

A pressurizing device for an electrode plate includes: a pressurizing unit; and a guide roller configured to guide the electrode plate to the pressurizing unit. The guide roller has a first region and second regions on opposite sides of the first region, and each of the second regions of the guide roller has a plurality of holes through which air is emitted.

### CROSS-REFERENCE TO RELATED APPLICATION

The present application claims priority to and the benefit of Korean Patent Application No. 10-2024-0158977, filed on November 11, 2024, in the Korean Intellectual Property Office, the entire disclosure of which is incorporated herein by reference.

### BACKGROUND

### 1. Field

Aspects of embodiments of the present disclosure relate to a pressurizing device for an electrode plate.

### 2. Description of the Related Art

A secondary battery is designed to be (re)charged and discharged, different from a primary battery, which is not designed to be (re)charged. Low-capacity secondary batteries are used in portable, small-sized electronic devices, such as smartphones, feature phones, laptop computers, digital cameras, and camcorders, while high-capacity secondary batteries are widely used as energy sources for driving motors in hybrid vehicles, electric vehicles, and the like, and for power storage (e.g., home- or utility-scale power storage).

A secondary battery generally includes an electrode assembly having a positive electrode and a negative electrode, a case housing the electrode assembly, electrode terminals connected to the electrode assembly, and the like.

An electrode plate may be wound and stacked to form an electrode assembly and may be manufactured by applying electrode slurry on a substrate, such as an aluminum foil or a copper foil.

The above-described information disclosed in this Background section is intended to improve understanding of the background of the present disclosure, and therefore, it may include information that does not constitute related (or prior) art.

### SUMMARY

Hereinafter, embodiments of the present disclosure will be described. However, aspects and features of the present disclosure are not limited to those described below, and other aspects and features of the present disclosure will be understood by the following description and will be more apparent from the embodiments of the present disclosure. Further, it will be readily understood that aspects and features of the present disclosure may be realized as forth in the appended claims and combinations thereof.

According to an embodiment of the present disclosure, a pressurizing device for an electrode plate includes: a pressurizing unit; and a guide roller configured to guide the electrode plate to the pressurizing unit. The guide roller has a first region and second regions on opposite sides of the first region, and each of the second regions having a plurality of holes through which air is emitted.

The electrode plate may have a coated portion and uncoated portions on opposite sides of the coated portion. The second regions may correspond to the uncoated portions, and the first region may correspond to the coated portion.

The guide roller may also include an air injection portion configured to inject the air.

The guide roller may have a cylindrical shape.

The plurality of holes may be arranged along a circumferential surface of the second regions.

Each of the plurality of holes may include an opening and closing portion.

The pressurizing device may further include a controller configured to control an open area of the opening and closing portions.

The open area of respective ones of the opening and closing portions may increase in a direction away from the first region along a longitudinal direction of the guide roller.

Areas of respective ones of the plurality of holes may increase in a direction away from the first region along a longitudinal direction of the guide roller.

An arrangement density of the holes may increase in a direction away from the first region along a longitudinal direction of the guide roller.

According to another embodiment of the present disclosure, a pressurizing device for an electrode plate is provided. The electrode plate has a coated portion and uncoated portions on opposite sides of the coated portion, and the pressurizing device includes: a pressurizing unit; and a guide roller configured to guide the electrode plate to the pressurizing unit. The guide roller has a first region and second regions on opposite sides of the first region, and each of the second regions having a plurality of holes through which air is emitted. The second regions may correspond to the uncoated portions, and the first region may correspond to the coated portion.

The guide roller may further include an air injection portion configured to inject the air.

The air flowing into the air injection portion may move through a passage inside the second regions and be discharged through the plurality of holes.

The guide roller may have a cylindrical shape.

The plurality of holes may be arranged along a circumferential surface of the second regions.

Each of the plurality of holes may include an opening and closing portion.

The pressurizing device may further include a controller configured to control an open area of the opening and closing portion.

The open area of respective ones of the opening and closing portion may increase in a direction away from the first region along a longitudinal direction of the guide roller.

Areas of the plurality of holes may increase in a direction away from the first region along a longitudinal direction of the guide roller.

An arrangement density of the plurality of holes may increase in a direction away from the first region along a longitudinal direction of the guide roller.

Other aspects, features, and embodiments, in addition to those described above, will become apparent from the following drawings, claims, and detailed description of the present disclosure.

### BRIEF DESCRIPTION OF THE DRAWINGS

The following drawings attached to this specification illustrate embodiments of the present disclosure and, together with the detailed description of the present disclosure, provide a further understanding of the technical idea of the present disclosure. Therefore, the present disclosure should not be interpreted as being limited to matters described in such drawings, in which:

FIG. 1 is a schematic view of a pressurizing device for an electrode plate according to an embodiment;

FIG. 2 is a perspective view of a pressurizing device for an electrode plate according to an embodiment;

FIG. 3 is a view of a state in which air is discharged from a second region of the guide roller toward an electrode plate according to an embodiment;

FIG. 4 is a perspective view of a controller of the pressurizing device for the electrode plate shown in FIG. 2;

FIG. 5 is a schematic cross-sectional view taken along the line A-A' in FIG. 2;

FIG. 6 is a schematic cross-sectional view taken along the line B-B' in FIG. 2;

FIGS. 7 and 8 show an opening and closing portion according to an embodiment;

FIG. 9 is a front view of opening and closing portions according to various embodiments;

FIGS. 10 to 12 are views of an opening and closing portion according to another embodiment; and

FIGS. 13 to 16 are views of an opening and closing portion according to other embodiments.

### DETAILED DESCRIPTION

Hereinafter, embodiments of the present disclosure will be described, in detail, with reference to the attached drawings. However, the terms or words used in this specification and claims should not be interpreted as limited to their usual or dictionary meanings but should be interpreted as having meanings and describing concepts that conform to the technical idea of the present disclosure based on the principle that the inventor can appropriately define the concept of the term in order to explain his or her own invention in the best way. The embodiments described in this specification and the configurations illustrated in the drawings are only some of the most embodiments of the present disclosure and do not represent all of the technical ideas of the present disclosure, and it should be understood that there may be various equivalents and modified examples that may replace those embodiments at the time of filing this application. Additionally, the terms "comprise or include" and/or "comprising or including" as used herein specify the presence of stated features, numbers, steps, operations, members, elements, and/or groups thereof, but do not preclude the presence or addition of one or more other features, numbers, operations, members, elements, and/or groups thereof. Upon describing embodiments of the present disclosure, the terms "may" and "may be" may include “one or more embodiments of the present disclosure.”

To help understanding of the present disclosure, the accompanying drawings are not drawn to scale, and the dimensions of some components may be exaggerated. Furthermore, the same element in different embodiments may be given the same reference number.

The expression indicating that the two comparison targets are equal to each other means that the two comparison targets are ‘substantially’ equal to each other. Therefore, the substantial equality may include a case in which a deviation considered as being at a low level in the art is present, for example, a deviation within about 5% is present. In addition, a configuration in which a certain parameter is constant in a predetermined region may mean that the parameter is constant from an average point of view.

Although the terms first, second, etc. are used to describe various components, these components are not limited by these terms. These terms are only used to distinguish one component from another, and unless otherwise stated, it is of course the case that a first component may also be a second component.

Throughout the specification, unless otherwise specifically stated, each element may be singular or plural.

Any configuration being placed ʺabove (or below)ʺ a component or ʺon (or under)ʺ a component may mean not only that any configuration is placed in contact with the upper surface (or lower surface) of a component, but also that other configurations may be interposed between the component and any configuration placed on (or below) the component.

Additionally, when it is described that a component is ʺconnected,ʺ ʺcoupled,ʺ or ʺfastenedʺ to another component, it should be understood that the components may be directly connected or fastened to one another, but that other components may also be ʺinterposedʺ between the components, or that each component may be ʺconnected,ʺ ʺcoupled,ʺ or ʺfastenedʺ through another component. Also, when it is said that a part is electrically coupled to another part, this includes not only cases where they are directly connected, but also cases where they are connected with another element in between.

Whenever reference is made throughout the specification to ʺA and/or B,ʺ this means A, B, or A and B, unless otherwise specified. That is, ʺand/orʺ includes all or any combination of listed items. ʺC through Dʺ refers to C or more and D or less, unless otherwise specified. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

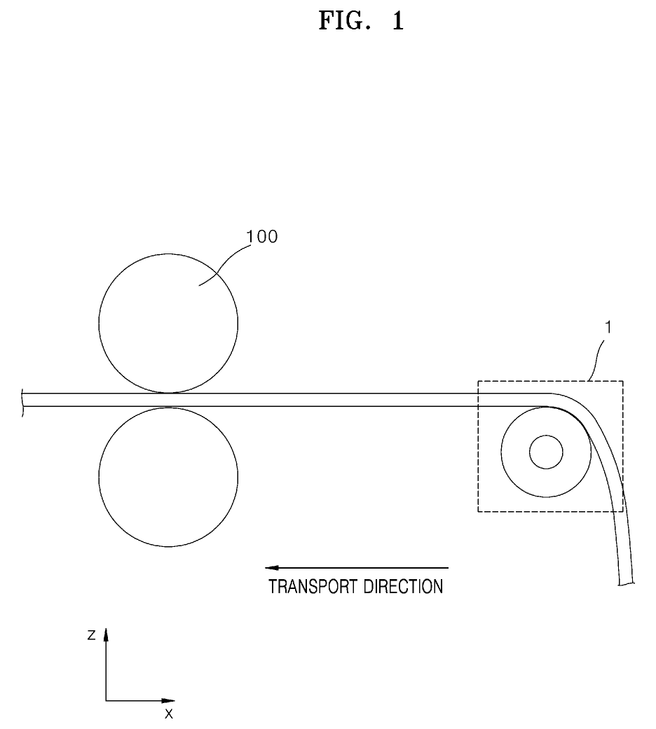

FIG. 1 is a schematic view of a pressurizing device for an electrode plate according to an embodiment and a pressurizing unit pressurizing the electrode plate.

As illustrated in FIG. 1, a pressurizing device for an electrode plate (also referred to as an electrode plate pressurizing device) 1, according to an embodiment, is a device employed (or used) to produce an electrode (e.g., an electrode plate) used in a secondary battery, such as a lithium ion battery, and the electrode plate may be a positive electrode plate for forming a positive electrode of the secondary battery or a negative electrode plate for forming a negative electrode of the secondary battery.

In this specification, the electrode plate may be used as an electrode in a battery, such as a lithium ion battery, and may be understood as being manufactured by applying an electrode slurry on a plate. In addition to this, the electrode plate 30 may participate in the electrochemical reaction of the battery and play a role in storing and emitting energy.

The term ʺplateʺ as used herein may indicate a base material on which the electrode slurry is coated. Generally, aluminum foil may be used for a positive electrode plate, and copper foil may be used for a negative electrode plate, but the positive electrode plate and the negative electrode plate are not limited thereto. In other embodiments, various modifications may be made, such as by using copper foil, nickel foil, stainless steel foil, titanium foil, nickel foam, copper foam, a polymer electrode plate coated with a conductive metal, and the like.

Electrode slurry as used herein may be a mixed material used to manufacture an electrode plate and may include a material mixed with an active material, a binder, an electrical conductor, a solvent, and the like.

For reference, the electrode plate may be divided into a coated portion on which the slurry is coated and uncoated portions on which the slurry is not coated.

Accordingly, the coated portion on which the slurry is coated may be thicker than the uncoated portions on which the slurry is not coated, and as such, a difference in tension may occur between the uncoated portions and the coated portion of the electrode plate as it passes a guide roller, causing damage, such as tearing or folding of the uncoated portions.

The difference in tension between the uncoated portions and the coated portion may be reduced or minimized by using the electrode plate pressurizing device 1 according to embodiments of the present disclosure in place of a conventional guide roller.

A pressurizing device for an electrode plate, according to an embodiment, may include a pressurizing unit 100 and a guide roller 200, which guides an electrode plate 30 to the pressurizing unit 100.

Referring to FIG. 1, the pressurizing unit 100 may refer to a pair of rolls (or rollers). As the electrode plate is compressed while passing through the rolls of the pressurizing unit 100, adhesion between a current collector and slurry may be improved, and a thickness of the electrode plate 30 may be reduced to improve energy density.

The guide roller 200 may be a device that guides the electrode plate 30 to the pressurizing unit 100 and may play a role in moving the electrode plate 30 to be inserted into the pressurizing unit 100 without damage.

The guide roller 200 may be rotated in one direction by receiving power from a motor. The guide roller 200 may be provided in plurality installed at spacings (e.g., at intervals) along a longitudinal direction of the electrode plate 30, such that the electrode plate 30 may be smoothly transported in a transport direction and, thereby, suppressing damage on the electrode plate 30.

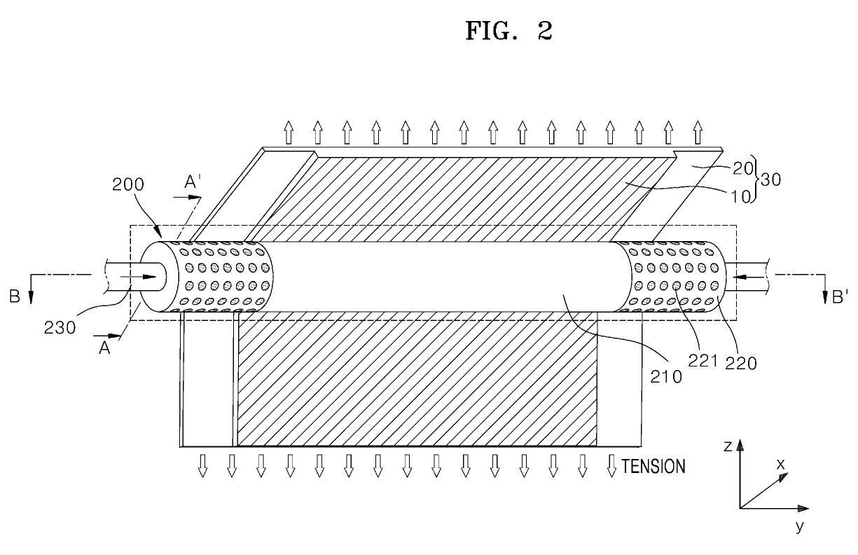

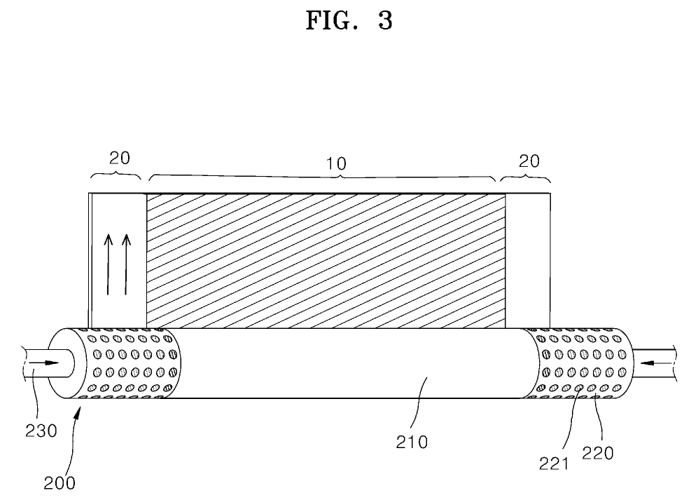

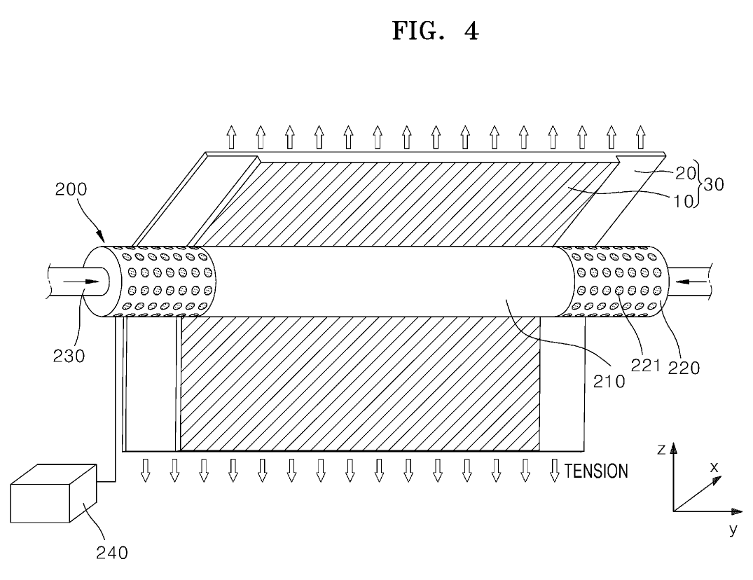

FIG. 2 is a perspective view of a pressurizing device for an electrode plate according to an embodiment, and FIG. 3 is a view of a state in which air discharged from a second region of a guide roller opposes an electrode plate according to an embodiment. FIG. 4 is a perspective view of a controller of the pressurizing device for the electrode plate shown in FIG. 2.

As illustrated in FIGS. 2 and 3, a guide roller 200 may have a first region 210 and second regions 220 arranged on opposite sides of the first region 210, and each of the second regions 220 may have a plurality of holes 221 through which air is injected (or emitted).

In some embodiments, an electrode plate 30 may have a coated portion 10 and uncoated portions 20 located on opposite sides of the coated portion 10. The second regions 220 of the guide roller 200 may correspond to the uncoated portions 20 of the electrode plate 30, respectively, and the first region 210 may correspond to the coated portion 10.

The guide roller 200 may have a cylindrical shape to ensure smooth transport of the electrode plate 30.

The plurality of holes 221 may be arranged along a circumferential surface of the corresponding second region 220.

In some embodiments, the plurality of holes 221 may be formed along the circumferential surface of the second region 220 and may be primarily arranged along a second direction y. Also, the second region 220 may have a length that is longer than that of the uncoated portion 20.

Accordingly, the second region 220 may sufficiently (or entirely) cover the region of the uncoated portion 20 so that compressed air discharged through the plurality of holes 221 may sufficiently pressurize the uncoated portion 20.

The electrode plate 30 may be transported while the uncoated portion 20 rolls along the second region 220. The plurality of holes 221 may be evenly arranged along the entire circumferential surface of the second region 220 to evenly inject air to (or toward) the uncoated portion 20, such that pressure is applied to the uncoated portion 20.

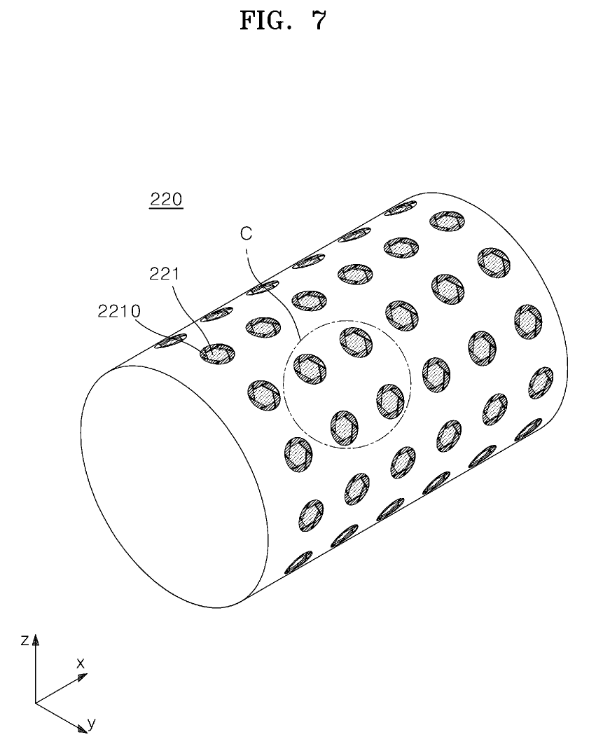

Next, referring to FIGS. 3 and 7, each of the plurality of holes 221 may have an opening and closing portion 2210.

The opening and closing portion 2210 may independently move to open and close the corresponding hole 221. In some embodiments, the state of the opening and closing portion 2210 may be determined depending on (or according to) the size of the electrode plate 30, the width of the uncoated portion 20, and the weight of the coated portion 10.

The opening and closing portion 2210 may also open and close a path between compressed air (e.g., an air inlet), which is transferred through the pressurizing unit 100 and a passage 231, and the second region 220, and may adjust a flow rate of the compressed air through the corresponding hole 221.

The arrangement and opening and closing pattern of the opening and closing portion 2210 may be modified in various suitable manners.

As illustrated in FIG. 4, the guide roller 200 may further include an air injection portion 230 for injecting air.

The air injection portion 230, according to an embodiment, may be connected to an air compressor, and air compressed by the air compressor may be introduced into the second region 220 through the air injection portion 230.

The air injection portion 230 may have a hollow cylindrical shape and may be arranged in one end of the second region 220. A portion between the air injection portion 230 and the second region 220 may be a path through which compressed air may move. Therefore, a connection method ensuring airtightness may be used.

For example, the air injection portion 230 and the second region 220 may be fastened in a form of a tube, which maintains airtightness, and for example, may be connected through welding or sealing, but the connection method is not limited thereto.

The electrode plate pressurizing device 1, according to an embodiment, may further include a controller 240 configured to control an open area of the opening and closing portion 2210.

The controller 240 may include a sensor and an external input device to perform signal transmission and reception with the controller 240.

The controller 240 may detect the weight or length of the electrode plate 30 and may control the open area of the opening and closing portion 2210 and the flow rate of air entering through the air injection portion 230.

The controller 240 may be physically present inside or outside the electrode plate pressurizing device 1 and may control the device based on a specific value directly input by a user and/or may transmit status information through a display.

The controller 240 may determine a pattern to operate the opening and closing portions 2210 of the plurality of holes 221, which move independently.

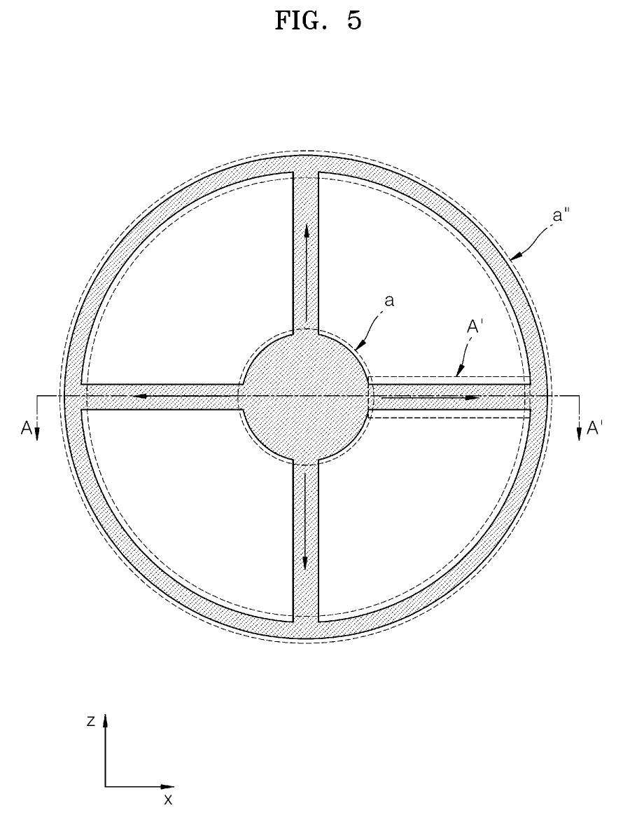

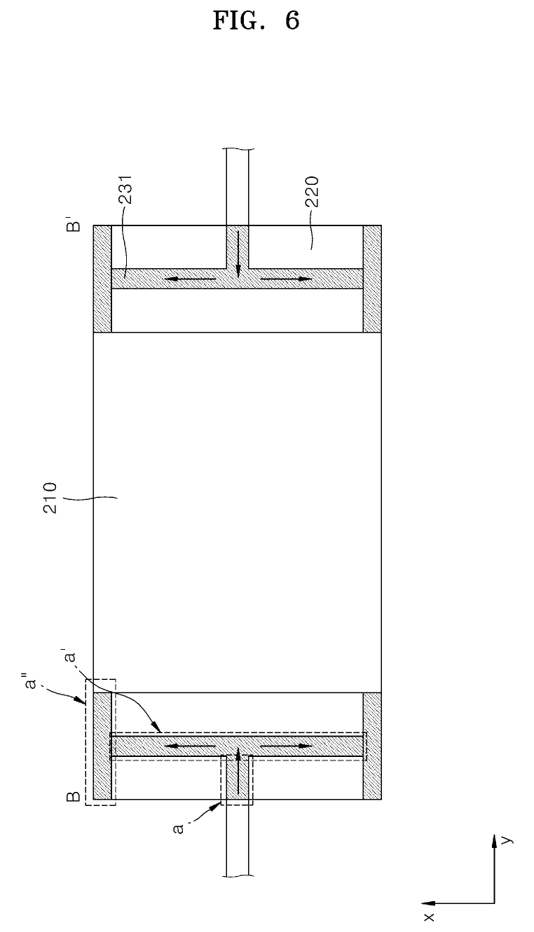

FIG. 5 is a schematic cross-sectional view taken along the line A-A' in FIG. 2, and FIG. 6 is a schematic cross-sectional view taken along the line B-B' in FIG. 2.

As illustrated in FIGS. 5 and 6, air flowing into the air injection portion 230 may move through the passage 231 inside the corresponding second region 220, and the air moving through the passage 231 may be discharged through the plurality of holes 221.

In terms of the passage 231, air may be injected through a central portion a of the passage 231, pass through a middle portion a' of the passage 231, and move to a passage discharge portion a'' located at an inner side of a circumference of the guide roller 200.

The passage discharge portion a'' may overlap lower surfaces of the plurality of holes 221 and may form a path through which air is discharged depending on the open areas of the opening and closing portions 2210.

The compressed air may be discharged through the plurality of holes 221 to apply appropriate pressure to the electrode plate 30, such that the coated portion 10 and the uncoated portions 20 may have constant tension.

Accordingly, an initial flow rate of compressed air may be determined in the air injection portion 230, the compressed air may move along the passage 231 and discharged through the plurality of holes 221.

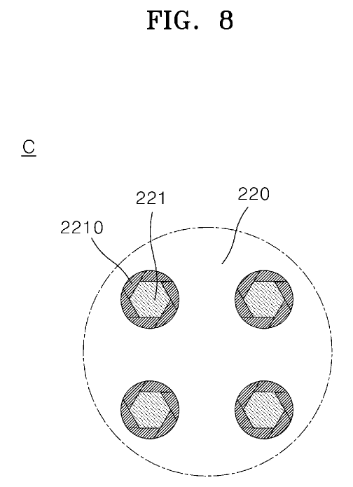

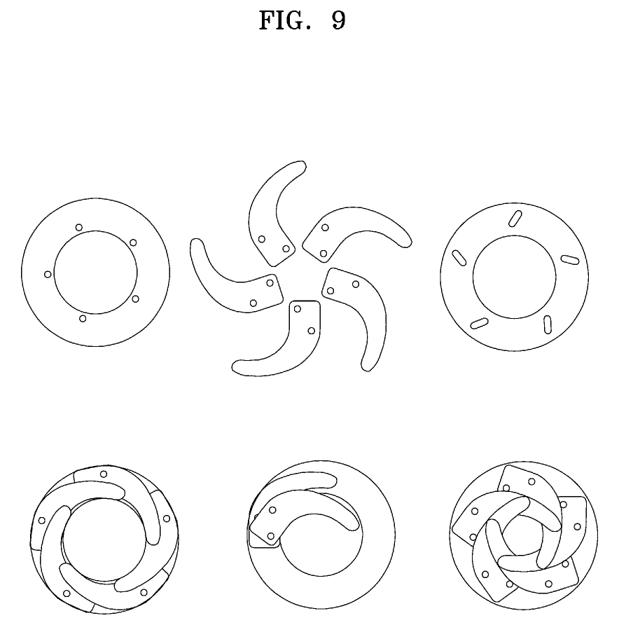

FIGS. 7 and 8 show an opening and closing portion according to an embodiment, and FIG. 9 is a front view of opening and closing portions according to various embodiments.

As illustrated in FIG. 7, the plurality of holes 221 may each have a circular shape, may be arranged along the circumferential surface of the second region 220, and may discharge air in a direction perpendicular to the circumferential surface.

The plurality of holes 221 may be spaced apart from each other at equal intervals.

Accordingly, regions where the compressed air pressurizes the electrode plate 30 may be evenly distributed, and then a process may proceed without any portion of the uncoated portion 20 which is not pressurized by the compressed air.

As illustrated in FIG. 8, referring to a partial view of the area C in FIG. 7 of the second region 220, each hole 221 may have one opening and closing portion 2210. The opening and closing portion 2210 may be formed to be selectively open and closed. For example, the opening and closing portion 2210 may include an aperture.

In some embodiments, the aperture may be less prone to wear and may be moved by less force, which may ensure long-term use. The aperture may exhibit an intuitive mechanical movement and, thus, may cause fewer errors or malfunctions, resulting in reducing maintenance costs.

Referring to FIG. 9, the aperture may be implemented in various shapes.

In some embodiments, the aperture may enable precise control of the opening and closing portion through a plurality of micro-blades. The micro-blade may have various shapes, as illustrated in FIG. 9, but is not limited thereto.

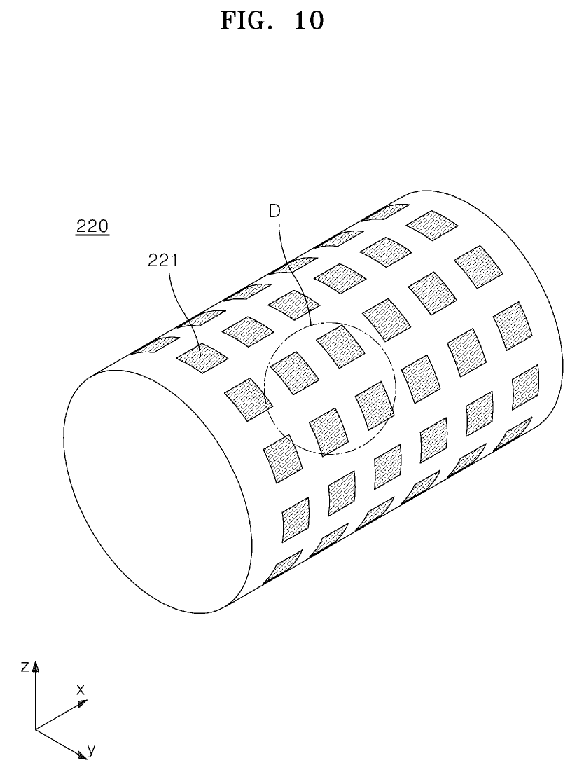

FIGS. 10 to 12 show an arrangement and size of an opening and closing portion according to another embodiment.

As illustrated in FIG. 10, the plurality of holes 221 may each have a square shape.

The plurality of holes 221 may each have a wider open area when each hole 221 has a square shape than when the hole has a circular shape. Accordingly, the guide roller 200 having the same size may control the tension of a heavy and/or larger electrode plate 30.

This allows for the efficient manufacturing a larger electrode assembly. The same effect may also be expected even when the electrode plate 30 becomes heavy due to the coated portion 10 being formed relatively thick to increase density.

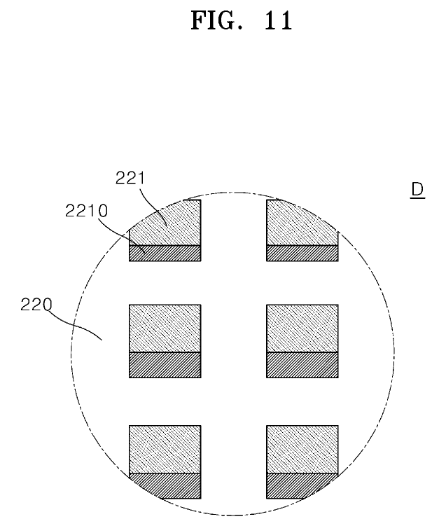

As illustrated in FIG. 11, referring to a partial view of the area D in FIG. 10 of the second region 220, the opening and closing portion 2210 may use a slide arranged on a lower surface of the corresponding hole 221 having a square shape.

The opening and closing portion 2210 using the slide may be subject to less mechanical wear even by repetitive opening and closing operations, thereby increasing durability. The opening and closing portion 2210 using the slide may also have high responsiveness to be open and closed quickly.

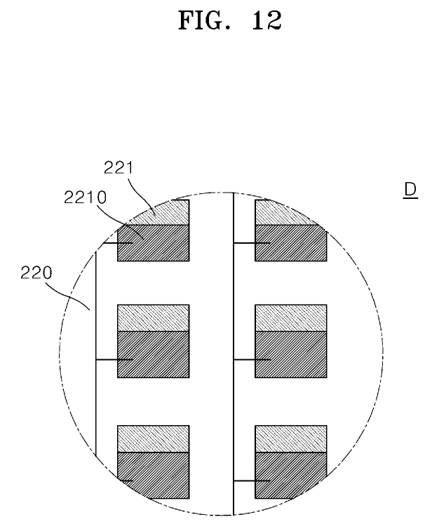

As illustrated in FIG. 12, the slide-type opening and closing portion 2210 may have an auxiliary line and may be controlled according to the movement of the auxiliary line.

In some embodiments, the auxiliary lines may control the opening and closing portions 2210 connected with the corresponding slides through one axis line and may determine strength of pressure applied in a transverse direction of the electrode plate 30.

In describing other embodiments of the present disclosure below, differences from the previous embodiments and modifications thereof illustrated in FIGS. 1 to 10 will be primarily described, and any redundant description with the previous embodiments will be omitted or abbreviated.

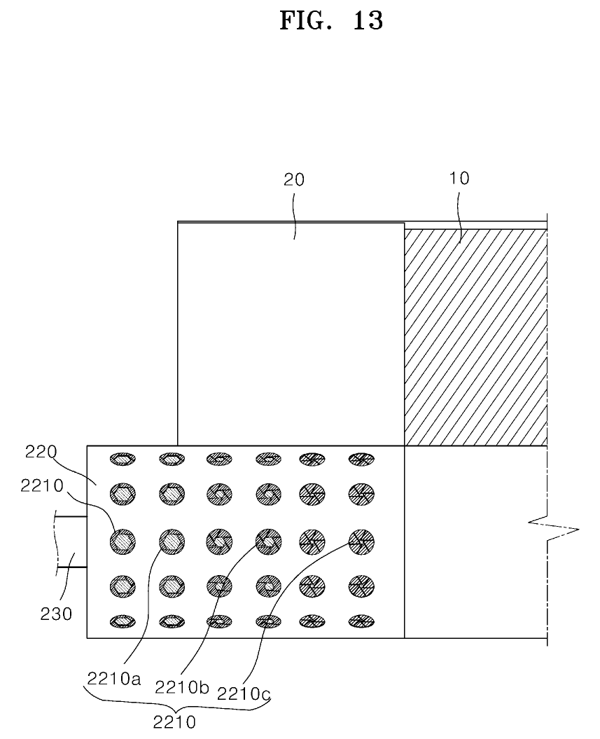

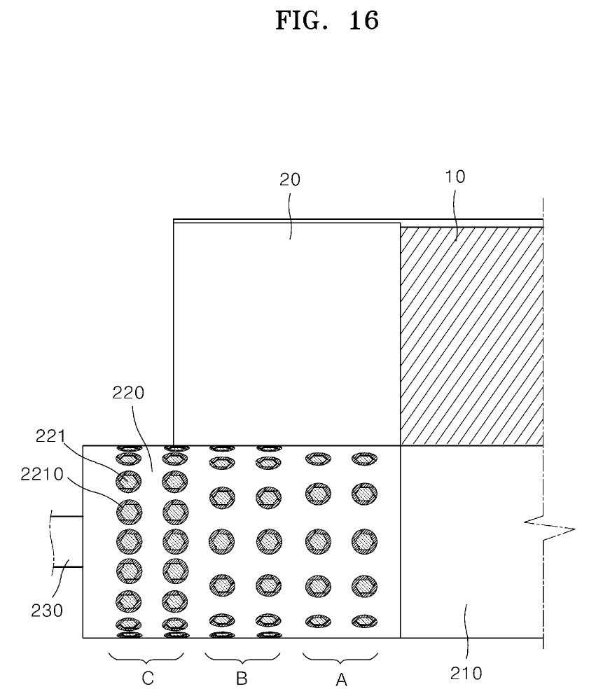

FIGS. 13 and 16 are front views of an opening and closing portion according to another embodiment.

As illustrated in FIG. 13, the opening and closing portion 2210 may have a wider open area away from the first region 210 in the longitudinal direction of the electrode plate pressurizing device 1.

The electrode plate 30 may be a thin plate and, thus, may be more easily rolled and receive more force in a transverse direction of the electrode plate 30.

During the process in which the electrode plate 30 is transported through the guide roller 200 to pass through the pressurizing unit 100, a difference in tension may occur due to a difference in thickness and weight between the coated portion 10 and the uncoated portion 20, which may cause damage, such as folding, tearing, or wrinkling.

As will be described below, such problems may be suppressed through the appropriate arrangement of the plurality of holes 221 of the electrode plate pressurizing device 1.

According to another embodiment, the open area of the opening and closing portion 2210 located far from the center of the guide roller 200 in the longitudinal direction of the electrode plate pressurizing device 1 may be wider than the open area of the opening and closing portion 2210 located close to the center of the guide roller 200 such that more pressure may be applied to an edge portion of the electrode plate 30 to suppress the electrode plate 30 from being rolled.

For example, as illustrated in FIG. 13, different pressure may be applied by increasing the open areas of the opening and closing portions 2210 from an opening and closing part 2210c, which is close to the center of the guide roller 200, toward a middle opening and closing part 2210b and a far opening and closing part 2210a.

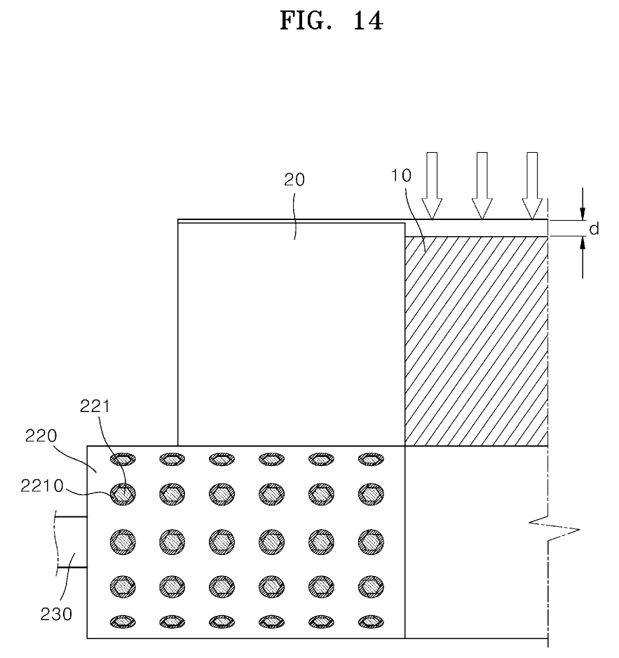

As illustrated in FIG. 14, the opening and closing portion 2210 may be open to have a wide open area when a thickness d of the coated portion 10 increases and, thereby, a weight of the electrode plate 30 increases.

In some embodiments, the opening and closing portions 2210 may generally have open areas that are wider toward the longitudinal direction of the electrode plate pressurizing device 1 when the weight of the electrode plate 30 is similar to that of an existing electrode plate 30 but may be fully open to have wide open areas when the weight of the electrode plate 30 or the length of the uncoated portion 20 increases, thereby applying more pressure to the uncoated portion 20 of the electrode plate 30.

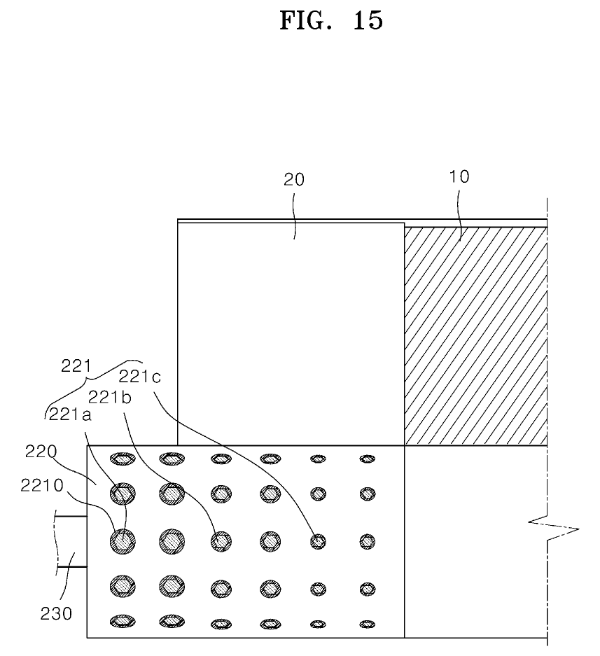

As illustrated in FIG. 15, the plurality of holes 221 may have wider areas away from the first region 210 in the longitudinal direction of the electrode plate pressurizing device 1.

As described above, to avoid problems, such as tearing, rolling, and wrinkling of the electrode plate 30, the sizes of the plurality of holes 221 may increase along the longitudinal direction of the electrode plate pressurizing device 1.

In this regard, the sizes of the plurality of holes 221 may change, and the sizes of the opening and closing portions 2210 may also increase or decrease relative to the changed sizes of the plurality of holes 221.

The plurality of holes 221 may be classified as small holes 221c adjacent to the first region 210, middle holes 221b, and large holes 221a.

The different holes 221a-221c may vary pressure applied in the transverse direction of the electrode plate 30, further improving an edge curling phenomenon of the electrode plate 30.

As illustrated in FIG. 16, the number of the plurality of holes 221 may increase away from the first region 210 along the longitudinal direction of the electrode plate pressurizing device 1.

In some embodiments, to apply more pressure to the edge portion of the electrode plate 30, the number of the plurality of holes 221 may increase along the longitudinal direction of the electrode plate pressurizing device 1.

Referring to FIG. 16, the arrangement density of the plurality of holes 221 in a region A, which is relatively close to the first region 210, may be lower than the arrangement density of the plurality of holes 221 in a region B, and the arrangement density of the plurality of holes 221 in the region B may be lower than the arrangement density of the plurality of holes 221 in a region C.

Accordingly, the density of the plurality of holes 221 in the second region 220 may more increase farther away from the first region 210, which further avoids damage to the electrode plate 30.

According to embodiments of the present disclosure, a pressurizing device for an electrode plate may apply pressure, by using air, to an uncoated portion of an electrode plate as a region excluding a coated portion of the electrode plate, thereby preventing the uncoated portion from being wrinkled before and after a pressurizing process.

Air pressure may be applied to the uncoated portion to ensure similar tension between the uncoated portion and the coated portion during the pressurizing process, thereby mitigating a problem with a quality deterioration of an electrode assembly due to damage to the uncoated portion.

However, aspects and features of the present disclosure are not limited to those described above, and other aspects and features not mentioned will be clearly understood by those skilled in the art.

While the present disclosure has been described herein in connection with a limited number of embodiments and drawings, the present disclosure is not limited thereto, and those skilled in the art would understand that various modifications and changes may be made thereto within the technical aspects of the present disclosure and the equivalent scope of the appended claims.

What is claimed is:

1. A pressurizing device for an electrode plate, the pressurizing device comprising:
a pressurizing unit; and
a guide roller configured to guide the electrode plate to the pressurizing unit, the guide roller having a first region and second regions on opposite sides of the first region, each of the second regions having a plurality of holes through which air is emitted.

2. The pressurizing device for the electrode plate as claimed in claim 1, wherein the electrode plate has a coated portion and uncoated portions on opposite sides of the coated portion,
wherein the second regions correspond to the uncoated portions, and
wherein the first region corresponds to the coated portion.

3. The pressurizing device for the electrode plate as claimed in claim 1, wherein the guide roller further comprises an air injection portion configured to inject the air.

4. The pressurizing device for the electrode plate as claimed in claim 1, wherein the guide roller has a cylindrical shape.

5. The pressurizing device for the electrode plate as claimed in claim 1, wherein the plurality of holes are arranged along a circumferential surface of the second regions.

6. The pressurizing device for the electrode plate as claimed in claim 1, wherein each of the plurality of holes comprises an opening and closing portion.

7. The pressurizing device for the electrode plate as claimed in claim 6, further comprising a controller configured to control an open area of the opening and closing portions.

8. The pressurizing device for the electrode plate as claimed in claim 7, wherein the open area of respective ones of the opening and closing portions increases in a direction away from the first region along a longitudinal direction of the guide roller.

9. The pressurizing device for the electrode plate as claimed in claim 1, wherein areas of respective ones of the plurality of holes increase in a direction away from the first region along a longitudinal direction of the guide roller.

10. The pressurizing device for the electrode plate as claimed in claim 1, wherein an arrangement density of the holes increases in a direction away from the first region along a longitudinal direction of the guide roller.

11. A pressurizing device for an electrode plate, the electrode plate having a coated portion and uncoated portions on opposite sides of the coated portion, the pressurizing device comprising:
a pressurizing unit; and
a guide roller configured to guide the electrode plate to the pressurizing unit, the guide roller having a first region and second regions on opposite sides of the first region, each of the second regions having a plurality of holes through which air is emitted,
wherein the second regions correspond to the uncoated portions, and
wherein the first region corresponds to the coated portion.

12. The pressurizing device for the electrode plate as claimed in claim 11, wherein the guide roller further comprises an air injection portion configured to inject the air.

13. The pressurizing device for the electrode plate as claimed in claim 12, wherein the air flowing into the air injection portion moves through a passage inside the second regions and is discharged through the plurality of holes.

14. The pressurizing device for the electrode plate as claimed in claim 11, wherein the guide roller has a cylindrical shape.

15. The pressurizing device for the electrode plate as claimed in claim 11, wherein the plurality of holes are arranged along a circumferential surface of the second regions.

16. The pressurizing device for the electrode plate as claimed in claim 11, wherein each of the plurality of holes comprises an opening and closing portion.

17. The pressurizing device for the electrode plate as claimed in claim 16, further comprising a controller configured to control an open area of the opening and closing portion.

18. The pressurizing device for the electrode plate as claimed in claim 17, wherein the open area of respective ones of the opening and closing portion increases in a direction away from the first region along a longitudinal direction of the guide roller.

19. The pressurizing device for the electrode plate as claimed in claim 11, wherein areas of the plurality of holes increase in a direction away from the first region along a longitudinal direction of the guide roller.

20. The pressurizing device for the electrode plate as claimed in claim 11, wherein the number of the plurality of holes increases in a direction away from the first region along a longitudinal direction of the guide roller.
